(19) United States
(12) Patent Application Publication
(10) Pub. No.: US 2026/0133880 A1
(43) Pub. Date: May 14, 2026

(54) MIGRATION FOR NETWORK-BASED VIRTUAL MACHINE REPLICATION

(71) Applicant: Hewlett Packard Enterprise Development LP, Spring, TX (US)

(72) Inventors: Omer Uretzky, Herzliya (IL); Gil Barash, Herzliya (IL)

(21) Appl. No.: 18/943,008

(22) Filed: Nov. 11, 2024

(51) Int. Cl. G06F 11/14

(52) U.S. Cl. CPC G06F 11/1451; G06F 11/1466; G06F 11/1469

(57) ABSTRACT

A method and system for replicating data change operations in a virtualized environment is provided. A data change filter and a data change driver in a hypervisor intercept data change operations from a virtual machine. A replication processing service receives a first stream of data change operations from the data change driver and a second stream from the data change filter. The service identifies a matching data change operation in both streams, replicates operations from the first stream up to a transition point, and then replicates operations from the second stream starting from the transition point. The transition point is pre-defined with respect to the matching data change operation. This approach enables seamless migration between driver-based and filter-based replication methods while maintaining data consistency and continuity.

### BACKGROUND

Virtualization technology allows multiple virtual machines to execute on a single physical host, improving resource utilization and flexibility in computing environments. These virtual machines function as independent systems, each with its own operating system and applications. By abstracting the hardware resources of a physical machine, virtualization enables the creation of multiple isolated virtual environments on a single physical server. This technology has revolutionized data centers and cloud computing, allowing for more efficient use of computing resources and greater scalability.

The concept of virtualization has gained significant traction in recent years due to advances in hardware and software capabilities. Modern virtualization platforms use a hypervisor, also known as a virtual machine monitor, to manage the allocation of physical resources to virtual machines. This layer of abstraction allows multiple operating systems and applications to share the same physical hardware without interfering with each other. Virtualization can be applied to various components of IT infrastructure, including servers, storage, and networks, providing a foundation for flexible computing environments.

Virtualization offers numerous benefits to organizations, including reduced hardware costs, improved energy efficiency, and simplified IT management. It enables rapid provisioning of new virtual machines, facilitates easier testing and development environments, and supports legacy applications on modern hardware. Additionally, virtualization enhances business continuity by allowing for easier migration of virtual machines between physical hosts. In a virtualized infrastructure, data backup and disaster recovery are important to protect against data loss and system failures.

### BRIEF DESCRIPTION OF THE DRAWINGS

For a more complete understanding of this disclosure, and advantages thereof, reference is now made to the following descriptions taken in conjunction with the accompanying drawings.

FIG. 1 is a block diagram of a virtualized environment, according to some implementations.

FIGS. 2A-2E are block diagrams of intermediate steps in a migration process for a data change filter, according to some implementations.

FIG. 3 is a block diagram of a virtualization host architecture, according to some implementations.

FIG. 4 is a flow diagram of a filter migration method, according to some implementations.

Corresponding numerals and symbols in the different figures generally refer to corresponding parts unless otherwise indicated.

### DETAILED DESCRIPTION

The following disclosure provides many different examples for implementing different features. Specific examples of components and arrangements are described below to simplify the present disclosure. These are, of course, merely examples and are not intended to be limiting.

Backup systems for virtualized environments often replicate virtual machines from one location to another for disaster recovery purposes. In one example, a backup system replicates a virtual machine by continuously capturing the data change operations made to the virtual machine and sending those data change operations to a backup site. Data change operations can be captured with a filter, which operates in the hypervisor of the virtualization host. This filter, also referred to as a data change filter, is a software component of the hypervisor that intercepts and copies the modifications made to the virtual machine's data. For example, the data change operations may be I/O operations, and the data change filter may be an input/output (I/O) filter that intercepts the I/O operations from the protected virtual machine. By operating within the hypervisor, the filter may capture data change operations with low impact on the virtual machine's performance. A replication processing service obtains the captured data change operations from the filter and handles the replication of those captured data change operations to the backup site. The data change operations may be received from the filter via any suitable communication channel, such as a network. A replication management service oversees the backup system, including the configuration and coordination of the data change filter and replication processing service.

One challenge in this backup system is upgrading components without interrupting an ongoing replication process. In some instances, the system may be migrated to the aforementioned data change filter from an older driver-based data change operation interceptor. Both the data change driver and the data change filter may capture data change operations from the protected virtual machine, but the data change driver may execute in the kernel space of the hypervisor while the data change filter may execute in the user space of the hypervisor. Thus, the data change filter may be more secure and less likely to result in system instability than the data change driver. The migration process aims to maintain data integrity and uninterrupted replication throughout the transition from the kernel space component to the user space component.

This disclosure describes a backup system that utilizes a multi-step migration process to transition from the data change driver to the data change filter without interrupting replication. First, the new data change filter is installed alongside the existing data change driver. Both the driver and the filter begin capturing data change operations from the protected virtual machine and sending the captured operations to the same replication processing service. Thus, the replication processing service receives two streams of data change operations-one from the data change driver and one from the data change filter-with those streams containing duplicated data change operations. However, the streams of data change operations may be temporally misaligned.

The replication processing service resolves this temporal misalignment of the streams by searching for a matching data change operation in both streams.

Specifically, it identifies the first data change operation of those received from the data change filter, and then searches for a matching operation among those received from the data change driver. Once it identifies the matching operation, the replication processing service uses it to establish a transition point where the data change operations from the data change filter should be replicated. The replication processing service processes the data change operations from the data change driver up to this point, then switches to processing the data change operations from the data change filter. Specifically, the data change operations from the data change driver before this point are replicated to the backup site, while the data change operations from the data change filter starting from this point are replicated to the backup site. The data change operations received from the data change driver after this point are discarded. In some implementations, replication state information may be merged from the data change driver into the data change filter during migration, thereby allowing the filter to recover from network connectivity interruptions after the migration process.

After the aforementioned switch is complete, the data change driver may be deactivated and uninstalled from the hypervisor. The multi-step migration process allows for a seamless transition that avoids downtime or interruption to the replication process. It helps avoid data loss during the migration by establishing a point in time, defined with respect to the matching data change operation, where the system transitions from using the data change driver's stream to the data change filter's stream.

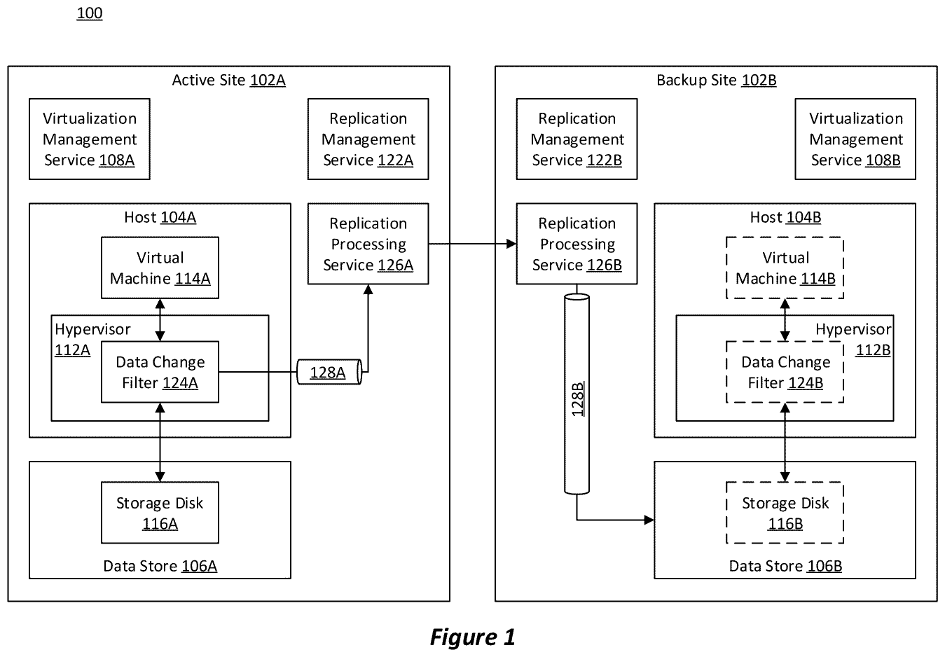

FIG. 1 is a block diagram of a virtualized environment 100, according to some implementations. The virtualized environment 100 includes multiple sites 102, including an active site 102A and a backup site 102B. In some aspects, replication is utilized to create and maintain backup copies of data and systems from the active site 102A to the backup site 102B. This configuration provides data protection and disaster recovery capabilities, allowing for operational continuity at the backup site 102B in case of failures at the active site 102A.

The active site 102A serves as the primary operational environment within the virtualized environment 100. It includes various components that work together to support the execution of virtual machines, including a host 104A, a data store 106A, and a virtualization management service 108A. While only one instance of each component is shown, there may be multiple instances of each component.

The host 104A may be a physical server that provides the computational resources necessary to run virtual machines. Thus, the host 104A may be referred to as a virtualization host. It executes a hypervisor 112A that manages the allocation of hardware resources to a virtual machine 114A running on the host 104A. The host 104A may also include various components to support virtualization and system management. In some aspects, the host 104A may incorporate hardware-assisted virtualization technologies, such as Intel VT-x or AMD-V, to improve performance and security of the virtual machine 114A. The host 104A may be equipped with a high-performance processor, ample memory, and fast storage interfaces to efficiently execute multiple virtual machines concurrently. Additionally, the host 104A may feature a network interface with support for advanced capabilities like Single Root I/O Virtualization (SR-IOV) to provide dedicated network resources to the virtual machine 114A. In some cases, the host 104A may also include specialized hardware accelerators for tasks such as encryption or graphics processing, which can be shared among virtual machines to enhance their capabilities. The host 104A may support live migration capabilities, allowing virtual machines to be moved between physical hosts with minimal downtime. It may also implement resource pools and distributed resource scheduling to optimize workload distribution across multiple hosts in a cluster.

The data store 106A is a storage system that provides the underlying storage infrastructure for the host 104A. It may include one or more storage devices, such as hard disk drives, solid-state drives, storage area networks, or the like. The data store 106A may contain virtual machine disk files, configuration files, and other data necessary for the operation of the virtual machine 114A running on the host 104A. For example, the data store 106A may include a storage disk 116A (which may be a physical or virtual disk) for the virtual machine 114A. In some aspects, the data store 106A utilizes advanced storage technologies like thin provisioning or deduplication to optimize storage utilization. It may also implement tiered storage architectures, where frequently accessed data is stored on high-performance media while less frequently accessed data is moved to lower-cost storage tiers. The data store 106A may support various storage protocols, such as Network File System (NFS), Internet Small Computer System Interface (ISCSI), or Fibre Channel, to provide flexible connectivity options for the host 104A. In some cases, the data store 106A incorporates features like data compression or encryption to enhance data security and reduce storage footprint. The data store 106A may support capabilities that allow virtual machine disks to be migrated between different storage systems without interrupting the running virtual machines. It may also implement storage policies to automate the placement and management of virtual machine data based on performance, availability, and compliance requirements.

The virtualization management service 108A is responsible for overseeing and controlling the virtualized environment on the active site 102A. It provides a centralized interface for managing the host 104A (including the virtual machine 114A) and the data store 106A (including the storage disk 116A). The virtualization management service 108A may handle tasks such as virtual machine provisioning, resource allocation, monitoring, and maintenance. It may also offer capabilities for creating and managing virtual networks, configuring storage policies, and implementing security measures across the virtualized infrastructure. In some aspects, the virtualization management service 108A provides features for performance optimization, capacity planning, and automated workload balancing among hosts. Additionally, the virtualization management service 108A may offer APIs and plugins to extend its functionality and integrate with third-party management tools.

The virtualization management service 108A may be implemented in any desired manner to suit the needs of the virtualized environment 100. The virtualization management service 108A may be deployed on a physical host, as a virtual machine on a host, using containerization technologies, or the like. More generally, the virtualization management service 108A may be executed on a management host (not separately illustrated in FIG. 1), which may be a physical or virtual host.

The active site 102A incorporates a backup system to ensure data protection and disaster recovery capabilities. This system utilizes replication, which continuously captures and transmits data change operations from the active site 102A to the backup site 102B. The backup site 102B may be different from the active site 102A. Specifically, the sites may be at different physical locations (e.g., different geographic locations) or different logical locations (e.g., different parts of a network). By replicating data in near real-time, the backup system may maintain an up-to-date copy of information at the backup site 102B, allowing for rapid recovery in case of failures at the active site 102A. The backup system includes a replication management service 122A, a data change filter 124A, and a replication processing service 126A at the active site 102A, which work together to replicate data change operations to the backup site 102B.

The replication management service 122A oversees the replication process within the active site 102A. It configures, coordinates, and monitors the various components involved in data replication. The replication management service 122A may interact with the virtualization management service 108A to manage protection of the virtual machine 114A and to gather necessary configuration details. It also manages the deployment and configuration of replication components in the active site 102A.

The replication management service 122A may be implemented in any desired manner to suit the needs of the virtualized environment 100. The replication management service 122A may be deployed on a physical host, as a virtual machine on a host, using containerization technologies, or the like. More generally, the replication management service 122A may be executed on a management host (not separately illustrated in FIG. 1), which may be a physical or virtual host.

The data change filter 124A is a specialized component installed in the hypervisor 112A of the host 104A. In some aspects, a data change filter is installed within the hypervisor of each host for which replication is desired. Its primary function is to intercept and capture data change operations from the virtual machine 114A running on the host 104A. A data change operation may include any modification to data stored on or accessed by the virtual machine 114A, such as write operations. A data change operation may include an I/O operation for the storage disk 116A, which may be file-agnostic as it operates at the block level of storage. In some implementations, a data change operation may include an offset (of the storage disk 116A) and binary data. Thus, the data change filter 124A operates at a low level (e.g., closer to the storage disk 116A than applications accessing the storage disk 116A), intercepting data change operations from the virtual machine 114A before they reach the corresponding storage disk 116A. In some implementations, the filter intercepts these operations asynchronously, allowing the original data change operation to proceed to the storage disk 116A without blocking or delaying it. This asynchronous interception enables the filter to capture data change operations without impacting the performance of the virtual machine 114A. The data change operations will be subsequently replicated to the backup site 102B. Continuously capturing and replicating these data change operations may allow for nearly real-time data protection, with only a minimal delay between when changes occur on the protected virtual machine 114A and when they are replicated to the backup site 102B.

The data change filter 124A is integrated into the I/O stack of the hypervisor 112A, functioning as a virtual I/O adapter that intercepts and captures data change operations from a virtual machine 114A at the block level. It may utilize networking communications (e.g., a TCP/IP-based communication protocol) to transmit captured data change operations to services that are external to the hypervisor 112A, working asynchronously to capture I/O operations without significantly impacting the performance of the virtual machine 114A. The data change filter 124A intercepts write operations, including storage offset and binary data information, on the way to the virtual machine's storage disk. In some implementations, it includes capabilities for data compression, batching, ensuring data integrity, and/or managing operation sequencing to maintain consistency in replicated data. The data change filter 124A runs in the user space of the hypervisor 112A instead of its kernel space, which may improve stability of the host 104A. This user space implementation may allow for easier updates and maintenance of the data change filter 124A without requiring changes to the core components of the hypervisor 112A.

The replication processing service 126A is responsible for processing and transmitting the data change operations captured from the virtual machine 114A to the backup site 102B. It may receive data change operations from the data change filter 124A, potentially across hosts. The replication processing service 126A may perform various tasks such as data compression, deduplication, and encryption before transmitting the changes over a network to the backup site 102B. It may also manage the sequencing and integrity of the replicated data to ensure consistency at the backup site 102B. In some aspects, the replication processing service 126A implements intelligent batching algorithms to optimize network usage and reduce latency. That is, the replication processing service 126A may aggregate the data change operations from the data change filter 124A and then batch them for sending to the backup site 102B, potentially at a configurable interval. For example, the replication processing service 126A may batch data change operations for 5 seconds before transmitting them to the backup site 102B. This allows administrators to configure a balance between replication frequency and network efficiency based on their specific requirements and network conditions. In some aspects, the replication processing service 126A replicates the data change operations without aggregation, which may allow for faster replication.

The replication processing service 126A may be implemented in any desired manner to suit the needs of the virtualized environment 100. The replication processing service 126A may be deployed on a physical host, as a virtual machine on a host, as a Virtual Replication Appliance (VRA) on a host, using containerization technologies, or the like. More generally, the replication processing service 126A may be executed on a replication host (not separately illustrated in FIG. 1), which may be a physical or virtual host.

The components of the active site 102A (including the host 104A and associated services) may be interconnected over any suitable type of network, including a local area network (LAN), a wide area network (WAN), the internet, a high-speed interconnect like InfiniBand, or the like. In some implementations, these network connections may utilize dedicated high-speed links between components to ensure low-latency and high-bandwidth communication for efficient data replication. The network infrastructure may include routers, switches, and firewalls configured to prioritize and secure the traffic between the data change filter 124A and the replication processing service 126A. The network infrastructure may also include virtual networking components provided by the hypervisor 112A. The network may support quality of service (QOS) mechanisms to prioritize or deprioritize replication traffic based on replication requirements and network conditions. In some cases, the network may leverage specialized protocols or optimizations designed for low-latency, high-throughput data transfer between components in the virtualized environment 100.

The replication processing service 126A is separate from the data change filter 124A. This separation allows for flexible deployment options and improved resource utilization. The replication processing service 126A may be executed on a dedicated replication host, which may be physical or virtual. The data change filter 124A and the replication processing service 126A may communicate over the network of the active site 102A, enabling them to operate on separate hosts. This network-based communication allows for various deployment scenarios, such as having multiple data change filters 124A on different virtualization hosts sending data to a replication processing service 126A on a single replication host. In some implementations, the replication processing service 126A replicates changes from multiple data change filters 124A to the backup site 102B.

The data change filter 124A may be connected to the replication processing service 126A through a network connection 128A, which may be a connection in the network of the active site 102A. This network connection 128A allows the data change filter 124A to transmit intercepted data change operations to the replication processing service 126A for processing and replication. Due to the network connection 128A, there is separation between the virtual machine 114A and the replication processing service 126A, with the data change filter 124A acting as an intermediary for data replication across the virtualization and replication hosts. As a result, the replication processing service 126A may run on a different host than the data change filter 124A.

The network connection 128A between the data change filter 124A and the replication processing service 126A may utilize a TCP/IP-based protocol optimized for low-latency, high-throughput data transfer. This protocol may implement a custom application layer designed specifically for efficient transmission of data change operations. The protocol may include features such as message framing, sequence numbering, and acknowledgment mechanisms to ensure reliable delivery of data change operations to the replication processing service 126A. Additionally, the protocol may support delta encoding, where only the differences between consecutive operations are transmitted, further reducing the amount of data sent over the network. The protocol may support connection pooling, allowing multiple logical streams of data change operations to be multiplexed over a single connection.

The network connection 128A may employ data compression techniques to reduce bandwidth usage. For example, the data change filter 124A may apply lossless compression algorithms such as LZ4 or Zstandard to the intercepted data change operations before transmission to the replication processing service 126A. The compression level may be configurable, and may be set by an administrator based on the desired compression efficiency and processing overhead.

The network connection 128A may employ security measures to protect the transmitted data. This may include using Transport Layer Security (TLS) for encryption and authentication, potentially using hardware-accelerated encryption on supported platforms. The protocol may implement a handshake process that includes mutual authentication between the data change filter 124A and the replication processing service 126A, potentially using pre-shared certificates. This authentication process may utilize public/private certificate pairs, such as certificate pairs that are generated by a service or system administrator. The use of these certificate pairs may allow for verifying the identity of both the sender and receiver of data change operations.

The aforementioned hosts (e.g., virtualization hosts, replication hosts, and management hosts) may include suitable components for performing any desired functionality. One or more modules within the hosts may be partially or wholly embodied as software and/or hardware for performing any functionality described herein. For example, a host may include a processor and a memory. The processor may be a microprocessor, an application-specific integrated circuit, a microcontroller, or the like. The memory may be a non-transitory computer readable medium that stores instructions for execution by the processor. The instructions, when executed by the processor, cause the processor to perform any functionality described herein.

The backup site 102B has similar components to the active site 102A but may be located at a different physical or logical location. It includes a host 104B, a data store 106B, a virtualization management service 108B, a hypervisor 112B, a virtual machine 114B, a storage disk 116B, a replication management service 122B, a data change filter 124B, a replication processing service 126B, and a network connection 128B, which may have similar functionality and be implemented in a similar manner as their counterparts at the active site 102A. While only one instance of each component is shown, there may be multiple instances of each component.

The backup site 102B is primarily used for replication and failover purposes, serving as a destination for data backed up from the active site 102A. In some cases, the backup site 102B remains in a standby state during normal operations, ready to take over in case of failures or disasters at the active site. The replication process between the active site 102A and the backup site 102B is managed by the replication management services 122A, 122B.

The replication processing service 126B is separate from the data change filter 124B. This separation allows for flexible failover operations, such as having multiple data change filters 124B on different virtualization hosts be managed by a replication processing service 126B on a single replication host.

In a replication flow for a virtual machine 114A, the data change filter 124A intercepts data change operations made by the virtual machine 114A to its storage disk 116A. These intercepted data change operations are then sent, by the data change filter 124A, to the replication processing service 126A. The replication processing service 126A processes the data change operations, replicating them to the corresponding replication processing service 126B at the backup site 102B. For example, the data change operations may be sent from the replication processing service 126A to the replication processing service 126B over a network connection. Upon receiving the replicated data change operations, the replication processing service 126B stores them in a journal, which may be located on the data store 106B at the backup site 102B. This journaling approach may allow for point-in-time recovery and provides a detailed record of all data change operations from the storage disk 116A, potentially enabling more granular restore options.

In a failover flow for a virtual machine 114A, the backup site 102B takes over operations from the active site 102A. The replication processing service 126B accesses the journal stored on the data store 106B to recover the data for the virtual machine 114A to a desired point in time. The recovered data is used to recreate a storage disk 116B in the data store 106B. A new virtual machine 114B is created on the host 104B at the backup site 102B, along with a corresponding data change filter 124B. This new virtual machine 114B is configured to use the recreated storage disk 116B, effectively becoming a replica of the original virtual machine 114A.

In some aspects, the storage disk 116B may be initially created as an empty disk so the virtual machine 114B may begin running quickly. Before the storage disk 116B is filled with restored data, the data change filter 124B may fetch needed data for the virtual machine 114B. Specifically, the data change filter 124B may forward a request for data from the virtual machine 114B to the replication processing service 126B, which may fetch the requested data from the journal and provide it to the data change filter 124B. Once the new virtual machine 114B is operational, the data change filter 124B captures new data change operations to the storage disk 116B. These new data change operations may be sent to the replication processing service 126B for further replication. The data change filter 124B may capture the new data change operations asynchronously or synchronously, depending on whether the storage disk 116B has been rebuilt. In some implementations, the data change filter 124B may capture the new data change operations synchronously during rebuilding of the storage disk 116B, temporarily blocking operations from proceeding to the storage disk 116B until relevant data of the storage disk 116B has been retrieved from the journal.

As subsequently described, the hypervisor 112 may be migrated to use the data change filter 124 from other components, such as driver-based data change interceptors. This migration process may be designed to occur seamlessly, so that data replication is not interrupted during the transition. The migration may involve installing the data change filter 124 alongside the existing data change driver in the hypervisor 112. Both components may then capture data change operations from the virtual machine 114 simultaneously. The replication processing service 126 may receive two streams of data change operations—one from the data change driver and one from the data change filter 124—and attempt to migrate while the streams of data change operations are being received from both components. This approach may enable the system to upgrade its data interception mechanism without disrupting ongoing replication processes, potentially enhancing system stability and security while maintaining data integrity.

The migration process may be initiated by a system administrator through the replication management service 122. For example, the administrator may issue a command or select an option to begin transitioning a hypervisor 112 from the data change driver to the data change filter 124. This action may trigger the replication management service 122 to install the data change filter 124 alongside the existing data change driver in the hypervisor 112 and perform migration.

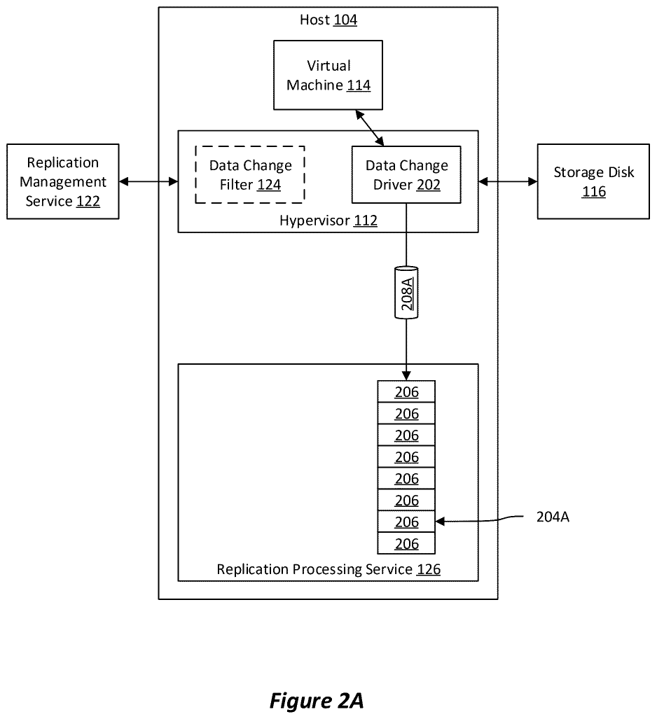

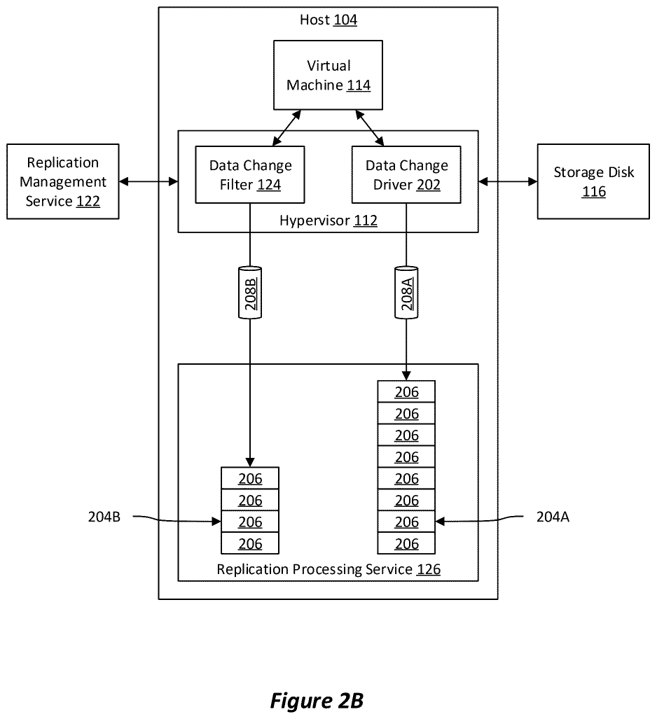

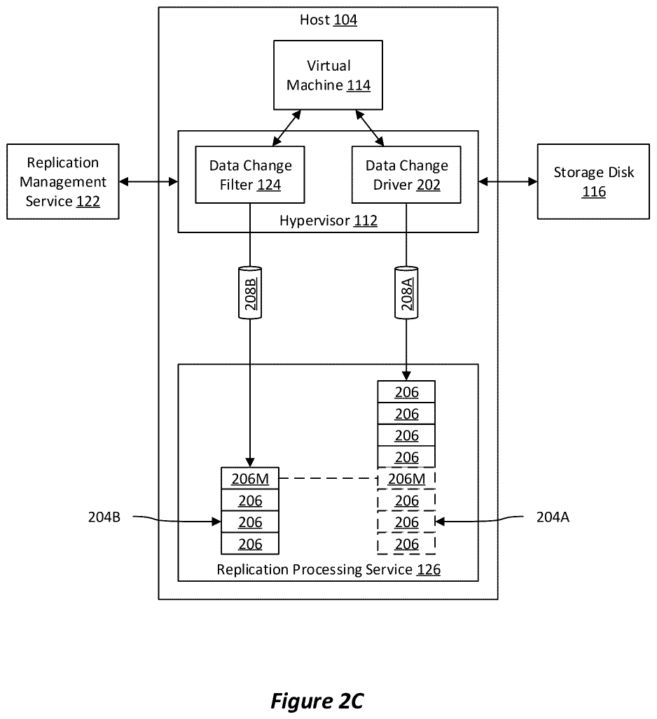

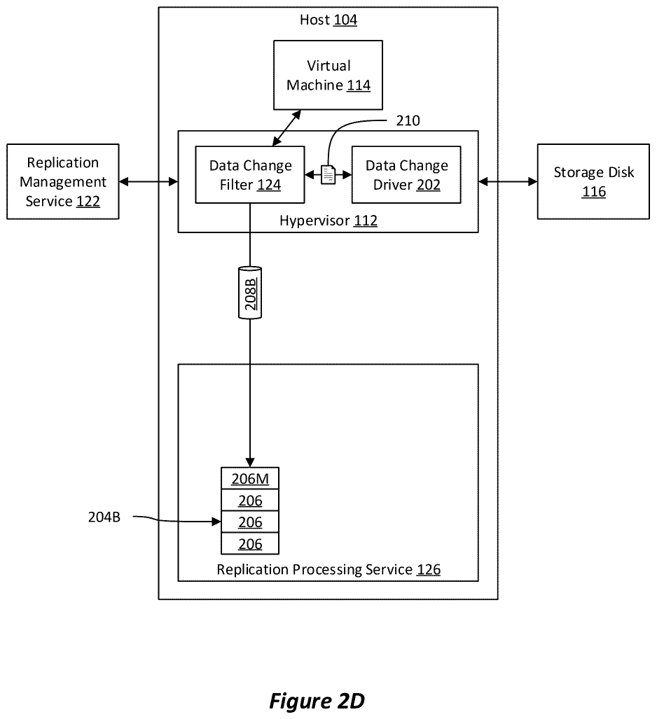

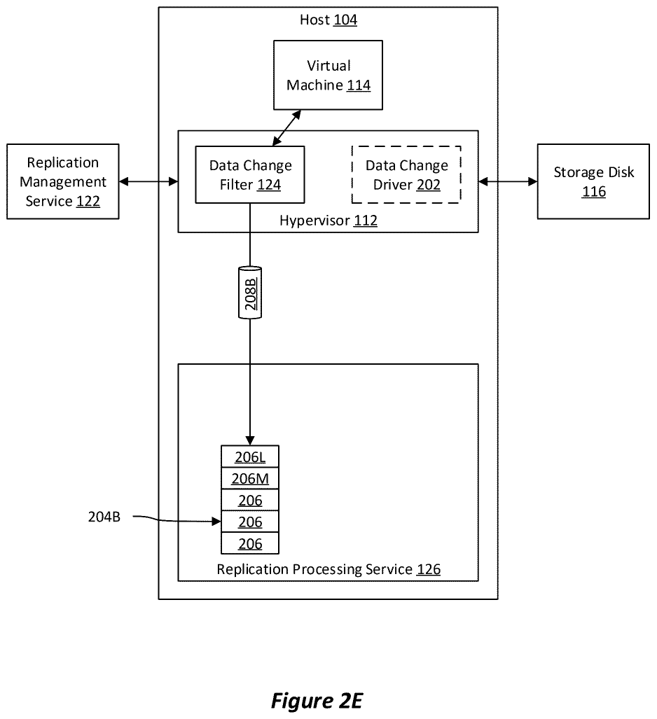

FIGS. 2A-2E are block diagrams of intermediate steps in a migration process for a data change filter 124, according to some implementations. In this configuration, a replication processing service 126 is deployed on a separate host 104 from a virtual machine 114 that will be backed up by the replication processing service 126. In another configuration, the virtual machine 114 and the replication processing service 126 may be deployed on the same host 104.

In FIG. 2A, a data change driver 202 is used in the hypervisor 112 of the host 104 running the virtual machine 114. The data change driver 202 intercepts data change operations 206 from the virtual machine 114. These data change operations 206 may be I/O operations for the storage disk 116 associated with the virtual machine 114.

The data change driver 202 executes at a low level within the hypervisor 112 (e.g., closer to the storage disk 116A than applications accessing the storage disk 116A), between the virtual machine 114 and the storage disk 116. This allows the data change driver 202 to monitor and capture the data change operations directed towards the storage disk 116. As the virtual machine 114 generates data change operations for the storage disk 116, the data change driver 202 intercepts these operations before they reach their destination disk. While intercepting the data change operations 206, the data change driver 202 creates a copy of each operation, allowing the original data change operation to proceed to the storage disk 116. In some aspects, the data change driver 202 may operate in the kernel space of the hypervisor 112, which allows for efficient interception of low-level I/O operations. This kernel-level operation may provide direct access to hardware resources and system calls of the hypervisor 112, potentially enabling fast processing of data change operations. However, the data change driver 202 operating at the kernel level may also raise security and/or stability concerns.

The data change driver 202 transmits a first stream 204A of the data change operations 206 to the replication processing service 126 via a communication channel 208A. The communication channel 208A facilitates communication between the data change driver 202 and the replication processing service 126. In some implementations, the communication channel 208A may be a control channel provided in the hypervisor 112. The control channel may be implemented using data control operations, which are different than data change operations, and are exchanged between the data change driver 202 and the replication processing service 126. The data control operations may have a special identifier which the data change driver 202 recognizes, intercepts, and processes. In other implementations, the communication channel 208A may be a network connection. Optionally, the data change driver 202 may compress, encrypt, or add metadata to the data change operations 206 before sending the first stream 204A of them over the communication channel 208A.

In some implementations, the data change driver 202 may operate asynchronously, capturing data change operations 206 without blocking them from proceeding to the storage disk 116. This asynchronous operation may allow the data change driver 202 to send the first stream 204A to the replication processing service 126 without impacting the performance of the virtual machine 114.

The replication processing service 126 may receive the first stream 204A of the data change operations 206 from the data change driver 202 and process them for replication to another service at a backup site. In some aspects, the replication processing service 126 may aggregate the received data change operations 206, compress them, or perform other optimizations before transmitting them to the backup site. In some implementations, the replication processing service 126 may batch multiple data change operations 206 together before replicating them to the backup site to reduce network overhead. The service at the backup site may then receive and journal the replicated data change operations 206 to maintain an up-to-date copy of the storage disk 116.

While the data change driver 202 is being used, a data change filter 124 is installed in the hypervisor 112 of the host 104 executing the virtual machine 114, as indicated by dashed lines in the figure. In some aspects, the data change filter 124 may be installed by the replication management service 122. The data change filter 124 will also intercept the data change operation 206 from the virtual machine 114, once configured (discussed below). In some implementations, the data change filter 124 runs in the user space of the hypervisor 112.

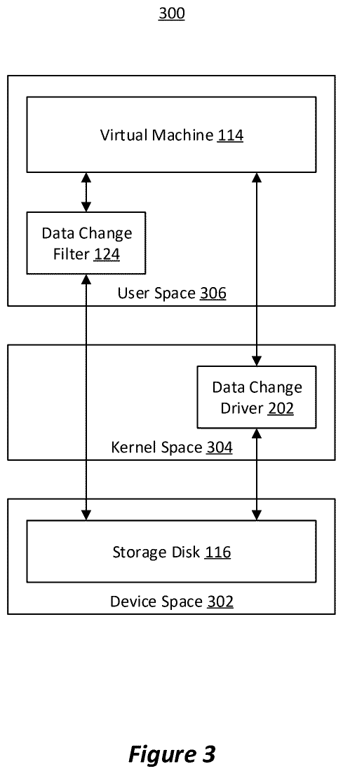

Referring briefly to FIG. 3, a block diagram of a virtualization host architecture 300 is shown, according to some implementations. The virtualization host architecture 300 includes components in different levels, including a device space 302, a kernel space 304, and a user space 306. Specifically, the storage disk 116 is in the device space 302; the data change driver 202 runs in the kernel space 304; and the data change filter 124 and the virtual machine 114 run in the user space 306. Running the data change filter 124 in the user space 306 may provide certain benefits compared to the kernel space 304, such as improved stability and easier updates. The user space implementation may allow the data change filter 124 to be modified or upgraded without requiring changes to the core hypervisor code. Additionally, operating in the user space 306 may enhance security by limiting the filter's access to sensitive system resources.

Referring back to FIG. 2A, in some implementations, the data change filter 124 may operate asynchronously, capturing data change operations 206 without blocking them from proceeding to the storage disk 116. This asynchronous operation may allow the data change filter 124 to send the second stream 204B to the replication processing service 126 without impacting the performance of the virtual machine 114.

In FIG. 2B, the data change filter 124 begins sending a second stream 204B of the data change operations 206 to the replication processing service 126 over a communication channel 208B. The data change filter 124 and data change driver 202 both communicate with the same replication processing service 126. In some aspects, the replication processing service 126 may instruct the data change filter 124 to start sending the second stream 204B. This instruction may be sent after the data change filter 124 is installed and configured in the hypervisor 112.

The communication channel 208B may be similar to or different from the communication channel 208A. Specifically, the communication channel 208B may be a different type of channel than the communication channel 208A. In some implementations, the communication channel 208A may be a control channel provided by the hypervisor 112, while the communication channel 208B may be a network connection.

The data change operations 206 sent by the data change filter 124 in the second stream 204B may include duplicates of the data change operations 206 sent by the data change driver 202 in the first stream 204A, as both components are intercepting the same operations from the virtual machine 114. However, the streams may be temporally misaligned due to differences in how the data change filter 124 and data change driver 202 process and transmit the operations over the communication channels 208A, 208B.

The replication processing service 126 may receive and buffer both the first stream 204A from the data change driver 202 and the second stream 204B from the data change filter 124. As subsequently described, this buffering may allow the replication processing service 126 to handle temporal misalignments between the two streams. In some aspects, at least some duplicate data change operations 206 may be buffered from both streams by the replication processing service 126. The replication processing service 126 may process data change operations 206 from both streams concurrently, enabling a seamless transition from using the data change driver 202 to using the data change filter 124 for replication.

In FIG. 2C, the replication processing service 126 identifies a matching data change operation 206M that appears in both the first stream 204A and the second stream 204B of the data change operations 206. In some aspects, the replication processing service 126 identifies the matching data change operation 206M after it has received at least some of the first stream 204A and the second stream 204B. The first stream 204A and second stream 204B may be temporally misaligned in some cases, with the matching data change operation 206M potentially appearing at different points in each stream.

In some implementations, the matching data change operation 206M may be the first data change operation 206 in the second stream 204B. The replication processing service 126 may identify this initial data change operation 206 at the beginning of the second stream 204B and then search for a matching data change operation 206 in the first stream 204A. By identifying the matching data change operation 206M as the first operation in the second stream 204B, the replication processing service 126 may ensure that it captures all data change operations 206 from the data change filter 124 at the point where the data change filter 124 began intercepting operations. The replication processing service 126 may then search through the buffered data change operations 206 from the first stream 204A to find the corresponding match. This search process may involve comparing various attributes of the data change operations 206, such as timestamps, operation types, or specific data content. In some aspects, the matching process may perform matching based on the offset of the storage disk 116 and binary data associated with each data change operation 206. The matching data change operation 206M may have the same offset and binary data in each stream.

In some cases, the matching process may need to account for potential differences in how the data change driver 202 and data change filter 124 represent or format the data change operations 206. The replication processing service 126 may apply transformation or normalization techniques to ensure accurate matching between the two streams.

The matching data change operation 206M may be used to establish a transition point between the two streams 204A, 204B, which the replication processing service 126 may use as a criteria to establish a clear starting point for transitioning from the data change driver 202 to the data change filter 124. The transition point is pre-defined with respect to the matching data change operation 206M. In some implementations, the transition point is the matching data change operation 206M. In some implementations, the transition point is another operation at an offset from the matching data change operation 206M. The replication processing service 126 processes the data change operations 206 from the first stream 204A up to (e.g., exclusive of) the transition point (e.g., the matching data change operation 206M or another operation offset therefrom). Specifically, those data change operation 206 from the first stream 204A are replicated to a service at a backup site. The replication processing service 126 then switches to processing operations from the second stream 204B starting from (e.g., inclusive of) the transition point. Again, those data change operation 206 from the second stream 204B are replicated to the service at the backup site. In some aspects, the replication processing service 126 may discard data change operations 206 from the first stream 204A starting from the transition point, as indicated by dashed lines in the figure. This approach may allow for a transition from using the data change driver 202 to the data change filter 124 for replicating the data change operation 206 from the virtual machine 114, while maintaining continuous replication. The data change driver 202 and data change filter 124 may operate concurrently for a period of time during the migration process, such as for a period of time after the transition point.

In FIG. 2D, the replication management service 122 directs the data change driver 202 to stop sending data change operations 206 to the replication processing service 126. Thus, the replication processing service 126 stops receiving the first stream 204A. The data change driver 202 may stop intercepting data change operations for the storage disk 116. At this point, the replication processing service 126 may only receive the second stream 204B from the data change filter 124. Optionally, the replication processing service 126 may perform cleanup operations on any remaining data associated with the first stream 204A, such as clearing buffers or the like.

Furthermore, the replication management service 122 may synchronize replication state information 210 across the data change driver 202 and the data change filter 124. Specifically, the data change driver 202 and the data change filter 124 may each maintain their own copy of the replication state information 210, and the state information from the data change driver 202 may be merged into the state information of the data change filter 124. As subsequently described, the replication state information 210 may be used by the replication processing service 126 to handle the loss or corruption of data change operations.

In some aspects, the replication state information 210 may include data about the current state of replication for the virtual machine 114. This information may include details such as which blocks of the storage disk 116 have been replicated, timestamps of the most recent replication events, and the like. Specifically, the replication state information 210 may include a map of sectors of the storage disk 116, indicating which have been modified. The map may be a bitmap, a B-tree, a hash table, or the like. In some implementations, the replication state information 210 is a bitmap, which is read from the data change driver 202 and provided to the data change filter 124 to be merged with an existing bitmap of the data change filter 124.

In FIG. 2E, a migration status for the data change filter 124 may be marked as complete. The replication management service 122 may update the system information to indicate that the data change filter 124 is now the primary component for intercepting and replicating data change operations 206 of the virtual machine 114. The data change driver 202 may then be deactivated from use with the virtual machine 114. The replication management service 122 may update configuration files, databases, or the like to reflect the completed migration from the data change driver 202 to the data change filter 124. For example, the replication management service 122 may use a database to track which hypervisors still need to be migrated from the driver-based interceptor to the filter-based interceptor, and that database may be updated after each migration process is complete.

Optionally, the data change driver 202 may be uninstalled from the hypervisor 112, as indicated by dashed lines in the figure. The uninstall process may be performed automatically by the replication management service 122 or manually by a system administrator. In some implementations, the replication management service 122 may perform cleanup operations, such as clearing any remaining buffers associated with the data change driver 202. Additionally, the replication management service 122 may update configuration files in the hypervisor 112 as part of the uninstall process.

The migration process may be considered complete when certain conditions are met. First, the replication processing service 126 may have successfully identified the transition point (e.g., the matching data change operation 206M or another operation offset therefrom) in both streams 204A, 204B and transitioned to processing the data change operations 206 solely from the second stream 204B. Second, the replication state information 210 may be successfully merged into the data change filter 124. Once these conditions are satisfied, the replication management service 122 may deactivate the data change driver 202. The system may notify an administrator that the migration process is complete. At this point, the administrator may choose to uninstall the data change driver 202 from the hypervisor 112, finalizing the transition to filter-based replication.

Failures may occur during the replication process. A failure may include an interruption in the communication channel between the data change driver 202 or data change filter 124 and its corresponding replication processing service 126. Additionally or alternatively, a failure may occur if the replication processing service 126 at the active site becomes disconnected from the replication processing service at the backup site, preventing data change operations 206 from being replicated between sites. In such cases, buffers storing the data change operations 206 at the data change driver 202, replication processing service 126, and/or data change filter 124 may become overloaded. Data change operation 206 may be lost when they are unable to be buffered. The recovery process for these failures may vary depending on when the failure occurs.

If a failure occurs after the migration process from the data change driver 202 to the data change filter 124 is complete, the recovery process may use the replication state information 210 (see FIG. 2D) to gracefully reconstruct and replicate a lost data change operation 206L. The lost data change operation 206L may be an operation that occurred before the matching data change operation 206M (and thus was received in the stream from the data change driver 202) or may be an operation that occurred after the matching data change operation 206M (and thus was received in the stream from the data change filter 124). For example, the lost data change operation 206L may be an operation that was received by the replication processing service 126 from the data change driver 202, but could not be replicated from the replication processing service 126 to the backup site due to network failures. The replication state information 210 may be a map of areas of the storage disk 116, containing an entry for each data change operation 206 that was sent to the replication processing service 126. To reconstruct the lost data change operation 206L, the system may read and replicate one or more areas of the storage disk 116 marked by the replication state information 210 that correspond to the lost operation. Effectively, the replication state information 210 may form a list of data change operations 206 that have been processed. Synchronizing the replication state information 210 from the data change driver 202 to the data change filter 124 may allow the data change filter 124 to gracefully reconstruct the lost data change operation 206L using state information even when that operation was intercepted by the data change driver 202 before transition.

If a failure occurs during the migration process from the data change driver 202 to the data change filter 124, the recovery process may include performing additional synchronization steps. If a network failure occurs between the replication processing service 126 and the data change driver 202 or data change filter 124 during migration, data change operation 206 may be lost and the replication state information 210 may become inaccessible to the replication processing service 126. As a result, the replication processing service 126 may be unable to gracefully reconstruct lost data change operations using state information. When operations are lost and graceful reconstruction using state information is not possible, the seamless migration process may be aborted. The replication processing service 126 may abort the migration process by deactivating the data change driver 202, discarding the first stream 204A of data change operation 206 received from the data change driver 202, and switching to replicating the second stream 204B of data change operation 206 received from the data change filter 124.

To recover lost data operations after an aborted seamless migration, the system may perform a full resynchronization of the storage disk 116. This full resynchronization may involve reading the entire contents of the storage disk 116, comparing it to the replicated data at the backup site, and identifying differences between them. Any detected differences at the storage disk 116 may then be replicated to bring the backup site into sync with the active site. In some implementations, the full resynchronization process may utilize checksums or other efficient comparison methods to minimize the amount of data that needs to be transferred to the backup site. The replication processing service 126 may coordinate this resynchronization process, potentially leveraging capabilities of the data change filter 124 to efficiently identify and replicate the changed sectors of the storage disk 116.

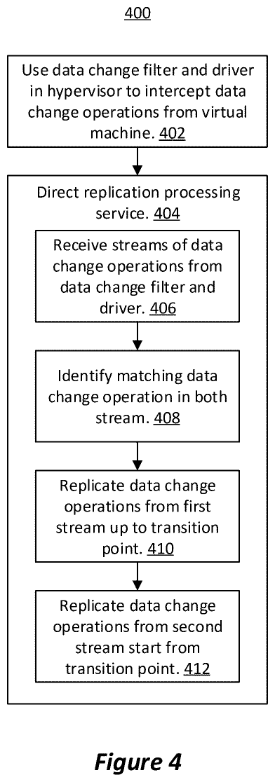

FIG. 4 is a flow diagram of a filter migration method 400, according to some implementations. The filter migration method 400 will be described in conjunction with the virtualized environment of FIGS. 2A-2E. The filter migration method 400 may be implemented by a management service. Specifically, the replication management service 122 may perform the filter migration method 400.

The replication management service 122 may perform a step 402 of using a data change filter 124 and a data change driver 202 in a hypervisor 112 of a virtualization host 104. The hypervisor 112 is configured to execute a virtual machine 114. The data change filter 124 is configured to intercept data change operations 206 from the virtual machine 114. The data change driver 202 is also configured to intercept the data change operations 206 from the virtual machine 114. The same data change operations 206 may be intercepted by both the data change filter 124 and the data change driver 202. The data change driver 202 may execute in a kernel space of the hypervisor 112 and the data change filter 124 may execute in a user space of the hypervisor 112.

The data change operations 206 may include input/output operations for a virtual storage disk 116. Each of the input/output operations may include an offset of the virtual storage disk 116 and binary data. The data change filter 124 may intercept the data change operations 206 by asynchronously copying the input/output operations without blocking the input/output operations from proceeding to the virtual storage disk 116.

The replication management service 122 may perform a step 404 of directing a replication processing service 126 to perform subsequent operations. This step may involve managing the replication processing service 126, such as configuring it to execute specific tasks related to the migration process.

The replication management service 122 may perform a step 406 of directing the replication processing service 126 to receive a first stream 204A of the data change operations 206 from the data change driver 202 and a second stream 204B of the data change operations 206 from the data change filter 124. Duplicate data change operations 206 may be present in the streams.

The replication management service 122 may perform a step 408 of directing the replication processing service 126 to identify a matching data change operation 206M in both the first stream 204A and the second stream 204B. The first stream 204A and the second stream 204B may be temporally misaligned and the matching data change operation 206M may be at the start of the second stream 204B.

The replication management service 122 may perform a step 410 of directing the replication processing service 126 to replicate the data change operations 206 from the first stream 204A up to a transition point. The transition point is-defined with respect to the matching data change operation 206M. When the transition point is the matching data change operation 206M, the data change operations 206 from the first stream 204A up to, but not including, the matching data change operation 206M are replicated by the replication processing service 126 to a backup site.

The replication management service 122 may perform a step 412 of directing the replication processing service 126 to replicate the data change operations 206 from the second stream 204B starting from the transition point. When the transition point is the matching data change operation 206M, the data change operations 206 from the second stream 204B starting from, and including, the matching data change operation 206M are replicated by the replication processing service 126 to a backup site. In some implementations, the replication management service 122 may also perform a step (not separately illustrated) of directing the replication processing service 126 to discard the data change operations 206 from the first stream 204A starting from the transition point.

In some implementations, the virtualization host 104 may be located at an active site 102A. The replication management service 122 may direct the replication processing service 126 to replicate the data change operations 206 (in steps 410 and 412) to a backup site 102B, which is in a different location than the active site 102A.

In some implementations, the replication management service 122 may also perform a step (not separately illustrated) of receiving a command to initiate migration from the data change driver 202 to the data change filter 124. In response to receiving the command, the replication management service 122 may install the data change filter 124 in the hypervisor 112 alongside the data change driver 202. The replication management service 122 may then uninstall the data change driver 202 from the hypervisor 112 after the migration process is complete.

In some implementations, the replication management service 122 may also perform a step (not separately illustrated) of directing the replication processing service 126 to merge replication state information 210 from the data change driver 202 into replication state information 210 of the data change filter 124. The replication management service 122 may direct the replication processing service 126 to reconstruct a lost data change operation 206L based on the replication state information 210 of the data change filter 124, where the lost data change operation 206L occurred before the matching data change operation 206M, and replicate the lost data change operation 206L. In some implementations, where the data change operations 206 include input/output operations for a virtual storage disk 116, the replication state information 210 of the data change filter 124 may include a map of areas of the virtual storage disk 116, and reconstructing the lost data change operation 206L may include reading one of the areas of the virtual storage disk 116 identified by the map.

In some implementations, the replication management service 122 may also perform a step (not separately illustrated) of directing the replication processing service 126 to rereplicate an entirety of the virtual storage disk 116 in response to losing connectivity with the data change filter 124 or the data change driver 202 when replicating the data change operations 206.

In an example implementation of the disclosure, a method includes: using a data change filter and a data change driver in a hypervisor of a virtualization host, the hypervisor configured to execute a virtual machine, the data change filter configured to intercept data change operations from the virtual machine, the data change driver also configured to intercept the data change operations from the virtual machine; and directing a replication processing service to: receive a first stream of the data change operations from the data change driver and a second stream of the data change operations from the data change filter; identify a matching data change operation in both the first stream and the second stream; replicate the data change operations from the first stream up to a transition point, the transition point being pre-defined with respect to the matching data change operation; and replicate the data change operations from the second stream starting from the transition point.

In some implementations, the method further includes: directing the replication processing service to discard the data change operations from the first stream starting from the transition point. In some implementations of the method, the first stream and the second stream are temporally misaligned and the matching data change operation is at the start of the second stream. In some implementations, the method further includes: receiving a command to initiate migration from the data change driver to the data change filter; and in response to receiving the command: installing the data change filter in the hypervisor alongside the data change driver; and uninstalling the data change driver from the hypervisor. In some implementations of the method, the data change driver executes in a kernel space of the hypervisor and the data change filter executes in a user space of the hypervisor. In some implementations, the method further includes: directing the replication processing service to merge replication state information from the data change driver into replication state information of the data change filter. In some implementations, the method further includes: directing the replication processing service to: reconstruct a lost data change operation based on the replication state information of the data change filter, where the lost data change operation occurred after the matching data change operation; and replicate the lost data change operation. In some implementations of the method, the data change operations include input/output operations for a virtual storage disk, the replication state information of the data change filter includes a map of areas of the virtual storage disk, and reconstructing the lost data change operation includes reading one of the areas of the virtual storage disk identified by the map. In some implementations of the method, the data change operations include input/output operations for a virtual storage disk, and the method further includes: directing the replication processing service to rereplicate an entirety of the virtual storage disk in response to losing connectivity with the data change filter or the data change driver when replicating the data change operations. In some implementations of the method, the data change operations include input/output operations for a virtual storage disk, and the data change filter intercepts the data change operations by asynchronously copying the input/output operations without blocking the input/output operations from proceeding to the virtual storage disk.

In an example implementation of the disclosure, a device includes: a processor; and a non-transitory computer readable medium storing instructions which, when executed by the processor, cause the processor to: receive a first stream of data change operations from a data change driver, the data change driver executing in a hypervisor, the hypervisor configured to execute a virtual machine, the data change driver configured to intercept data change operations from the virtual machine; receive a second stream of the data change operations from a data change filter, the data change filter executing in the hypervisor, the data change filter also configured to intercept the data change operations from the virtual machine; identify a matching data change operation in both the first stream and the second stream; replicate the data change operations from the first stream up to a transition point, the transition point being pre-defined with respect to the matching data change operation; and replicate the data change operations from the second stream starting from the transition point.

In some implementations of the device, the instructions further cause the processor to: merge replication state information from the data change driver into replication state information of the data change filter; and replicate a lost data change operation based on the replication state information of the data change filter.

In an example implementation of the disclosure, a system includes: a virtualization host located at an active site, the virtualization host configured to: execute a virtual machine on a hypervisor; and intercept data change operations from the virtual machine using a data change driver and also using a data change filter, the data change driver executing in a kernel space of the hypervisor, the data change filter executing in a user space of the hypervisor; and a first replication host located at the active site, the first replication host configured to: receive a first stream of the data change operations from the data change driver and a second stream of the data change operations from the data change filter; identify a matching data change operation in both the first stream and the second stream; replicate the data change operations from the first stream up to a transition point, the transition point being pre-defined with respect to the matching data change operation; and replicate the data change operations from the second stream starting from the transition point.

In some implementations of the system, the first stream and the second stream are temporally misaligned and the matching data change operation is the first data change operation in the second stream. In some implementations, the system further includes: a second replication host located at a backup site, the backup site different from the active site, where the first replication host is configured to replicate the data change operations to the second replication host. In some implementations, the system further includes: a data store located at the backup site, where the second replication host is configured to journal the data change operations on the data store. In some implementations of the system, the first replication host receives the first stream of the data change operations over a first communication channel with the data change driver, the first replication host receives the second stream of the data change operations over a second communication channel with the data change filter, and the second communication channel is a different type of channel than the first communication channel. In some implementations of the system, the data change operations include input/output operations for a virtual storage disk, and the first replication host is further configured to: rereplicate an entirety of the virtual storage disk in response to an interruption in the first communication channel or the second communication channel. In some implementations of the system, the first replication host is further configured to: synchronize replication state information across the data change driver and the data change filter; and after synchronizing the replication state information, replicate a lost data change operation based on the replication state information. In some implementations of the system, the data change operations include input/output operations for a virtual storage disk, and the replication state information includes an entry for each of the input/output operations.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

1. A method comprising:
using a data change filter and a data change driver in a hypervisor of a virtualization host, the hypervisor configured to execute a virtual machine, the data change filter configured to intercept data change operations from the virtual machine, the data change driver also configured to intercept the data change operations from the virtual machine; and
directing a replication processing service to:
receive a first stream of the data change operations from the data change driver and a second stream of the data change operations from the data change filter;
identify a matching data change operation in both the first stream and the second stream;
replicate the data change operations from the first stream up to a transition point, the transition point being pre-defined with respect to the matching data change operation; and
replicate the data change operations from the second stream starting from the transition point.

2. The method of claim 1, further comprising:
directing the replication processing service to discard the data change operations from the first stream starting from the transition point.

3. The method of claim 1, wherein the first stream and the second stream are temporally misaligned and the matching data change operation is at a start of the second stream.

4. The method of claim 1, further comprising:
receiving a command to initiate migration from the data change driver to the data change filter; and
in response to receiving the command:
installing the data change filter in the hypervisor alongside the data change driver; and
uninstalling the data change driver from the hypervisor.

5. The method of claim 1, wherein the data change driver executes in a kernel space of the hypervisor and the data change filter executes in a user space of the hypervisor.

6. The method of claim 1, further comprising:
directing the replication processing service to merge replication state information from the data change driver into replication state information of the data change filter.

7. The method of claim 6, further comprising:
directing the replication processing service to:
reconstruct a lost data change operation based on the replication state information of the data change filter, wherein the lost data change operation occurred after the matching data change operation; and
replicate the lost data change operation.

8. The method of claim 7, wherein the data change operations comprise input/output operations for a virtual storage disk, the replication state information of the data change filter comprises a map of areas of the virtual storage disk, and reconstructing the lost data change operation comprises reading one of the areas of the virtual storage disk identified by the map.

9. The method of claim 1, wherein the data change operations comprise input/output operations for a virtual storage disk, and the method further comprises:
directing the replication processing service to rereplicate an entirety of the virtual storage disk in response to losing connectivity with the data change filter or the data change driver when replicating the data change operations.

10. The method of claim 1, wherein the data change operations comprise input/output operations for a virtual storage disk, and the data change filter intercepts the data change operations by asynchronously copying the input/output operations without blocking the input/output operations from proceeding to the virtual storage disk.

11. A device comprising:
a processor; and
a non-transitory computer readable medium storing instructions which, when executed by the processor, cause the processor to:
receive a first stream of data change operations from a data change driver, the data change driver executing in a hypervisor, the hypervisor configured to execute a virtual machine, the data change driver configured to intercept data change operations from the virtual machine;
receive a second stream of the data change operations from a data change filter, the data change filter executing in the hypervisor, the data change filter also configured to intercept the data change operations from the virtual machine;
identify a matching data change operation in both the first stream and the second stream;
replicate the data change operations from the first stream up to a transition point, the transition point being pre-defined with respect to the matching data change operation; and
replicate the data change operations from the second stream starting from the transition point.

12. The device of claim 11, wherein the instructions further cause the processor to:
merge replication state information from the data change driver into replication state information of the data change filter; and
replicate a lost data change operation based on the replication state information of the data change filter.

13. A system comprising:
at least one processor;
a non-transitory computer readable medium storing instructions including a virtualization host located at an active site, the virtualization host, when executed by the at least one processor to:
execute a virtual machine on a hypervisor; and
intercept data change operations from the virtual machine using a data change driver and also using a data change filter, the data change driver executing in a kernel space of the hypervisor, the data change filter executing in a user space of the hypervisor; and
a second at least one processor;
a second non-transitory computer readable medium storing instructions including a first replication host located at the active site, the first replication host, when executed by the at least one processor to:
receive a first stream of the data change operations from the data change driver and a second stream of the data change operations from the data change filter;
identify a matching data change operation in both the first stream and the second stream;
replicate the data change operations from the first stream up to a transition point, the transition point being pre-defined with respect to the matching data change operation; and
replicate the data change operations from the second stream starting from the transition point.

14. The system of claim 13, wherein the first stream and the second stream are temporally misaligned and the matching data change operation is a first data change operation in the second stream.

15. The system of claim 13, further comprising:
a second replication host located at a backup site, the backup site different from the active site,
wherein the first replication host is configured to replicate the data change operations to the second replication host.

16. The system of claim 15, further comprising:
a data store located at the backup site,
wherein the second replication host is configured to journal the data change operations on the data store.

17. The system of claim 13, wherein the first replication host receives the first stream of the data change operations over a first communication channel with the data change driver, the first replication host receives the second stream of the data change operations over a second communication channel with the data change filter, and the second communication channel is a different type of channel than the first communication channel.

18. The system of claim 17, wherein the data change operations comprise input/output operations for a virtual storage disk, and the first replication host is further configured to:
rereplicate an entirety of the virtual storage disk in response to an interruption in the first communication channel or the second communication channel.

19. The system of claim 13, wherein the first replication host is further configured to:
synchronize replication state information across the data change driver and the data change filter; and
after synchronizing the replication state information, replicate a lost data change operation based on the replication state information.

20. The system of claim 19, wherein the data change operations comprise input/output operations for a virtual storage disk, and the replication state information comprises an entry for each of the input/output operations.
